(19) United States
(12) Patent Application Publication
(10) Pub. No.: US 2024/0267823 A1
(43) Pub. Date: Aug. 8, 2024

(54) INDICATING TIME WINDOW FOR CONDITIONAL HANDOVER

(71) Applicant: Nokia Technologies Oy, Espoo (FI)

(72) Inventors: Klaus Ingemann PEDERSEN, Aalborg (DK); Ahmad AWADA, Munich (DE)

(21) Appl. No.: 18/564,728

(22) PCT Filed: Jun. 24, 2021
(86) PCT No.: PCT/EP2021/067277

§ 371 Date: Nov. 28, 2023

(51) Int. Cl. H04W 36/36; H04W 36/00

(52) U.S. Cl. CPC H04W 36/362; H04W 36/00837

(57) ABSTRACT

Disclosed is a method comprising receiving an indication indicating one or more time windows, during which a handover is allowed to be initiated; evaluating whether one or more conditions for the handover are fulfilled within the one or more time windows; and initiating the handover during one of the one or more time windows, if the one or more conditions are fulfilled.

### FIELD

The following exemplary embodiments relate to wireless communication.

### BACKGROUND

In a handover procedure, a cellular transmission may be transferred from one cell to another. However, if the handover is not timed appropriately, it may lead to a negative impact on the quality of the cellular transmission. Therefore, it is desirable to provide an improved handover procedure.

### SUMMARY

The scope of protection sought for various exemplary embodiments is set out by the independent claims. The exemplary embodiments and features, if any, described in this specification that do not fall under the scope of the independent claims are to be interpreted as examples useful for understanding various exemplary embodiments.

According to an aspect, there is provided an apparatus comprising at least one processor, and at least one memory including computer program code, wherein the at least one memory and the computer program code are configured, with the at least one processor, to cause the apparatus to: receive an indication indicating one or more time windows, during which a handover is allowed to be initiated; evaluate whether one or more conditions for the handover are fulfilled within the one or more time windows; and initiate the handover during one of the one or more time windows, if the one or more conditions are fulfilled.

According to another aspect, there is provided an apparatus comprising means for: receiving an indication indicating one or more time windows, during which a handover is allowed to be initiated; evaluating whether one or more conditions for the handover are fulfilled within the one or more time windows; and initiating the handover during one of the one or more time windows, if the one or more conditions are fulfilled.

According to another aspect, there is provided a method comprising: receiving an indication indicating one or more time windows, during which a handover is allowed to be initiated; evaluating whether one or more conditions for the handover are fulfilled within the one or more time windows; and initiating the handover during one of the one or more time windows, if the one or more conditions are fulfilled.

According to another aspect, there is provided a computer program comprising instructions for causing an apparatus to perform at least the following: receive an indication indicating one or more time windows, during which a handover is allowed to be initiated; evaluate whether one or more conditions for the handover are fulfilled within the one or more time windows; and initiate the handover during one of the one or more time windows, if the one or more conditions are fulfilled.

According to another aspect, there is provided a computer program product comprising program instructions which, when run on a computing apparatus, cause the computing apparatus to perform at least the following: receive an indication indicating one or more time windows, during which a handover is allowed to be initiated; evaluate whether one or more conditions for the handover are fulfilled within the one or more time windows; and initiate the handover during one of the one or more time windows, if the one or more conditions are fulfilled.

According to another aspect, there is provided a computer readable medium comprising program instructions for causing an apparatus to perform at least the following: receive an indication indicating one or more time windows, during which a handover is allowed to be initiated; evaluate whether one or more conditions for the handover are fulfilled within the one or more time windows; and initiate the handover during one of the one or more time windows, if the one or more conditions are fulfilled.

According to another aspect, there is provided a non-transitory computer readable medium comprising program instructions for causing an apparatus to perform at least the following: receive an indication indicating one or more time windows, during which a handover is allowed to be initiated; evaluate whether one or more conditions for the handover are fulfilled within the one or more time windows; and initiate the handover during one of the one or more time windows, if the one or more conditions are fulfilled.

According to another aspect, there is provided an apparatus comprising at least one processor, and at least one memory including computer program code, wherein the at least one memory and the computer program code are configured, with the at least one processor, to cause the apparatus to: determine one or more time windows, during which no downlink user plane data is expected to be transmitted to a terminal device, and during which no uplink user plane data is expected to be received from the terminal device; and indicate, to the terminal device, that the terminal device is allowed to initiate a handover during the one or more time windows, if one or more conditions are fulfilled.

According to another aspect, there is provided an apparatus comprising means for: determining one or more time windows, during which no downlink user plane data is expected to be transmitted to a terminal device, and during which no uplink user plane data is expected to be received from the terminal device; and indicating, to the terminal device, that the terminal device is allowed to initiate a handover during the one or more time windows, if one or more conditions are fulfilled.

According to another aspect, there is provided a method comprising: determining one or more time windows, during which no downlink user plane data is expected to be transmitted to a terminal device, and during which no uplink user plane data is expected to be received from the terminal device; and indicating, to the terminal device, that the terminal device is allowed to initiate a handover during the one or more time windows, if one or more conditions are fulfilled.

According to another aspect, there is provided a computer program comprising instructions for causing an apparatus to perform at least the following: determine one or more time windows, during which no downlink user plane data is expected to be transmitted to a terminal device, and during which no uplink user plane data is expected to be received from the terminal device; and indicate, to the terminal device, that the terminal device is allowed to initiate a handover during the one or more time windows, if one or more conditions are fulfilled.

According to another aspect, there is provided a computer program product comprising program instructions which, when run on a computing apparatus, cause the computing apparatus to perform at least the following: determine one or more time windows, during which no downlink user plane data is expected to be transmitted to a terminal device, and during which no uplink user plane data is expected to be received from the terminal device; and indicate, to the terminal device, that the terminal device is allowed to initiate a handover during the one or more time windows, if one or more conditions are fulfilled.

According to another aspect, there is provided a computer readable medium comprising program instructions for causing an apparatus to perform at least the following: determine one or more time windows, during which no downlink user plane data is expected to be transmitted to a terminal device, and during which no uplink user plane data is expected to be received from the terminal device; and indicate, to the terminal device, that the terminal device is allowed to initiate a handover during the one or more time windows, if one or more conditions are fulfilled.

According to another aspect, there is provided a non-transitory computer readable medium comprising program instructions for causing an apparatus to perform at least the following: determine one or more time windows, during which no downlink user plane data is expected to be transmitted to a terminal device, and during which no uplink user plane data is expected to be received from the terminal device; and indicate, to the terminal device, that the terminal device is allowed to initiate a handover during the one or more time windows, if one or more conditions are fulfilled.

According to another aspect, there is provided a system comprising at least a terminal device and a base station. The base station is configured to: determine one or more time windows, during which no downlink user plane data is expected to be transmitted to the terminal device, and during which no uplink user plane data is expected to be received from the terminal device; and transmit, to the terminal device, an indication indicating that the terminal device is allowed to initiate a handover during the one or more time windows, if one or more conditions are fulfilled. The terminal device is configured to: receive the indication from the base station; evaluate whether the one or more conditions for the handover are fulfilled within the one or more time windows; and initiate the handover during one of the one or more time windows, if the one or more conditions are fulfilled.

According to another aspect, there is provided a system comprising at least a terminal device and a base station. The base station comprises means for: determining one or more time windows, during which no downlink user plane data is expected to be transmitted to the terminal device, and during which no uplink user plane data is expected to be received from the terminal device; and transmitting, to the terminal device, an indication indicating that the terminal device is allowed to initiate a handover during the one or more time windows, if one or more conditions are fulfilled. The terminal device comprises means for: receiving the indication from the base station; evaluating whether the one or more conditions for the handover are fulfilled within the one or more time windows; and initiating the handover during one of the one or more time windows, if the one or more conditions are fulfilled.

### BRIEF DESCRIPTION OF THE DRAWINGS

In the following, various exemplary embodiments will be described in greater detail with reference to the accompanying drawings, in which

FIG. 1 illustrates an exemplary embodiment of a cellular communication network;

FIG. 2 illustrates an exemplary timing diagram for extended reality traffic;

FIG. 3 illustrates a signaling diagram according to an exemplary embodiment;

FIG. 4 illustrates an example of a time window pattern according to an exemplary embodiment;

FIGS. 5-6 illustrate flow charts according to some exemplary embodiments;

FIGS. 7-8 illustrate apparatuses according to some exemplary embodiments.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different exemplary embodiments will be described using, as an example of an access architecture to which the exemplary embodiments may be applied, a radio access architecture based on long term evolution advanced (LTE Advanced, LTE-A) or new radio (NR, 5G), without restricting the exemplary embodiments to such an architecture, however. It is obvious for a person skilled in the art that the exemplary embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wideband code division multiple access (WCDMA), systems using ultra-wideband (UWB) technology, sensor networks, mobile ad-hoc networks (MANETs) and Internet Protocol multimedia subsystems (IMS) or any combination thereof.

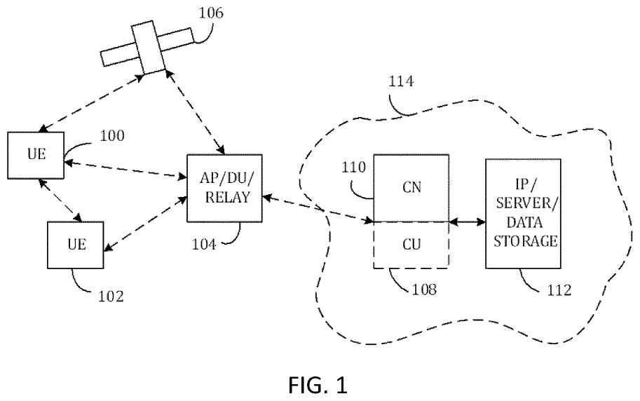

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The exemplary embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g) NodeB may be called uplink or reverse link and the physical link from the (e/g) NodeB to the user device may be called downlink or forward link. It should be appreciated that (e/g)NodeBs or their functionalities may be implemented by using any node, host, server or access point etc. entity suitable for such a usage.

A communication system may comprise more than one (e/g)NodeB, in which case the (e/g)NodeBs may also be configured to communicate with one another over links, wired or wireless, designed for the purpose. These links may be used for signaling purposes. The (e/g)NodeB may be a computing device configured to control the radio resources of communication system it is coupled to. The (e/g) NodeB may also be referred to as a base station, an access point or any other type of interfacing device including a relay station capable of operating in a wireless environment. The (e/g)NodeB may include or be coupled to transceivers. From the transceivers of the (e/g)NodeB, a connection may be provided to an antenna unit that establishes bi-directional radio links to user devices. The antenna unit may comprise a plurality of antennas or antenna elements. The (e/g) NodeB may further be connected to core network 110 (CN or next generation core NGC). Depending on the system, the counterpart on the CN side may be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface may be allocated and assigned, and thus any feature described herein with a user device may be implemented with a corresponding apparatus, such as a relay node. An example of such a relay node may be a layer 3 relay (self-backhauling relay) towards the base station.

The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation may be carried out in the cloud. The user device (or in some exemplary embodiments a layer 3 relay node) may be configured to perform one or more of user equipment functionalities. The user device may also be called a subscriber unit, mobile station, remote terminal, access terminal, user terminal, terminal device, or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may be expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave, below 6 GHz-cmWave-mmWave). One of the concepts considered to be used in 5G networks may be network slicing in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or a radio unit (RU), or a base station comprising radio parts. It may also be possible that node operations will be distributed among a plurality of servers, nodes or hosts. Carrying out the RAN real-time functions at the RAN side (in a distributed unit, DU 104) and non-real time functions in a centralized manner (in a central unit, CU 108) may be enabled for example by application of cloudRAN architecture.

It should also be understood that the distribution of labour between core network operations and base station operations may differ from that of the LTE or even be non-existent. Some other technology advancements that may be used may be Big Data and all-IP, which may change the way networks are being constructed and managed. 5G (or new radio, NR) networks may be designed to support multiple hierarchies, where MEC servers may be placed between the core and the base station or nodeB (gNB). It should be appreciated that MEC may be applied in 4G networks as well.

5G may also utilize satellite communication to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). At least one satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may also comprise other apparatuses, such as physical layer relay nodes or other network elements, etc. At least one of the (e/g)NodeBs or may be a Home(e/g)nodeB.

Furthermore, the (e/g)nodeB or base station may also be split into: a radio unit (RU) comprising a radio transceiver (TRX), i.e. a transmitter (TX) and a receiver (RX); one or more distributed units (DUs) that may be used for the so-called Layer 1 (L1) processing and real-time Layer 2 (L2) processing; and a central unit (CU) or a centralized unit that may be used for non-real-time L2 and Layer 3 (L3) processing. The CU may be connected to the one or more DUs for example by using an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU may be defined as a logical node hosting higher layer protocols, such as radio resource control (RRC), service data adaptation protocol (SDAP) and/or packet data convergence protocol (PDCP), of the (e/g)nodeB or base station. The DU may be defined as a logical node hosting radio link control (RLC), medium access control (MAC) and/or physical (PHY) layers of the (e/g)nodeB or base station. The operation of the DU may be at least partly controlled by the CU. The CU may comprise a control plane (CU-CP), which may be defined as a logical node hosting the RRC and the control plane part of the PDCP protocol of the CU for the (e/g)nodeB or base station. The CU may further comprise a user plane (CU-UP), which may be defined as a logical node hosting the user plane part of the PDCP protocol and the SDAP protocol of the CU for the (e/g)nodeB or base station.

Cloud computing platforms may also be used to run the CU and/or DU. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of labour between the above-mentioned base station units, or different core network operations and base station operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The (e/g) NodeBs of FIG. 1 may provide any kind of these cells. A cellular radio system may be implemented as a multilayer network including several kinds of cells. In multilayer networks, one access node may provide one kind of a cell or cells, and thus a plurality of (e/g) NodeBs may be needed to provide such a network structure.

For fulfilling the need for improving the deployment and performance of communication systems, the concept of “plug-and-play” (e/g)NodeBs may be introduced. A network which may be able to use “plug-and-play” (e/g)NodeBs, may include, in addition to Home (e/g)NodeBs (H(e/g)nodeBs), a home node B gateway, or HNB-GW (not shown in FIG. 1). A HNB Gateway (HNB-GW), which may be installed within an operator's network, may aggregate traffic from a large number of HNBs back to a core network.

To provide a continuous service for a moving UE, a handover procedure, which may also be referred to as handoff, may be performed to change the UE from one cell to another. The UE may transmit measurement reports to its serving cell, if the radio link to the serving cell is getting degraded and/or a neighbour cell quality is becoming better than the serving cell quality. Based on these measurement reports, the network may move (i.e. hand over) the UE connection from the serving cell to the neighbour cell by transmitting a handover command to the UE. For example, when a UE with an ongoing call or data session is moving away from an area covered by the serving cell and entering an area covered by a neighbor cell, the session may be handed over from the gNB of the serving cell to the gNB of the neighbor cell in order to avoid terminating or interrupting the session, when the UE gets outside the range of the serving cell.

A conditional handover (CHO) may be defined as a handover that is executed by the UE, when one or more handover execution conditions are met. In other words, the UE receives a handover command with a CHO configuration indicating one or more handover execution conditions, but the UE does not execute the handover command until the one or more conditions are met. The UE may start evaluating the execution condition(s) upon receiving the CHO configuration from the gNB, and stop evaluating the execution condition(s) once a handover is executed. An advantage of CHO is that it improves the mobility robustness compared to legacy handover by reducing the number of radio link failures and handover failures. This is achieved by de-coupling the handover execution phase from the preparation phase, thus enabling the UE to receive the handover command early when the radio link of the source cell is still sufficient and executing the handover later when the radio link of the target cell is strong enough.

The CHO configuration comprises the configuration of CHO candidate cell(s) generated by the candidate gNB(s) and execution condition(s) generated by the source gNB.

An execution condition may comprise one or more trigger condition(s), for example CHO event A3 and/or CHO event A5. One or more reference signal types may be supported and one or more trigger quantities may be configured for the evaluation of the CHO execution condition of a single candidate cell. The one or more trigger quantities may comprise, for example, reference signal received power (RSRP), reference signal received quality (RSRQ), and/or signal-to-interference-plus-noise ratio (SINR).

CHO event A3 means that a trigger quantity of a CHO candidate cell indicated in the CHO configuration exceeds the trigger quantity of the serving cell by an offset for a certain time-to-trigger (TTT) period.

CHO event A5 means that the trigger quantity of the serving cell becomes lower than a first threshold, and the trigger quantity of a CHO candidate cell indicated in the CHO configuration exceeds a second threshold for a certain TTT period.

Before any CHO execution condition is satisfied, upon reception of a handover command (without CHO configuration), the UE may execute the handover procedure, regardless of any previously received CHO configuration.

While executing a CHO, i.e. from the time when the UE starts synchronization with the target cell, the UE is not able to monitor the source cell.

The source gNB may configure the UE with CHO as part of an RRC reconfiguration message including information element(s) (e.g. conditionalReconfiguration) associated with CHO. The conditionalReconfiguration information element comprises a configuration of candidate target special cell(s) (SpCell) and execution condition(s) for conditional handover or conditional primary secondary cell (PSCell) change. For conditional PSCell change, this field may be present in an RRC reconfiguration message for intra-SN (secondary node) PSCell change. It should be noted that the network may not configure the UE with both conditional primary cell (PCell) change and conditional PSCell change at a time. The field may be absent, if any dual active protocol stack (DAPS) bearer is configured, or if the masterCellGroup includes ReconfigurationWithSync. For conditional PSCell change, the field may be absent, if the secondaryCellGroup includes ReconfigurationWithSync. The RRC reconfiguration message contained in DLInformationTransferMRDC cannot contain the field conditionalReconfiguration for conditional PSCell change.

However, currently a mechanism may be missing for the network to control at which times the UE is allowed to execute a CHO.

CHO may also be used for extended reality (XR) services, such as cloud gaming (CG). XR is a term referring to real-and-virtual combined environments and human-machine interactions generated by computer technology and wearables. XR is an umbrella term including augmented reality (AR), virtual reality (VR), mixed reality (MR), and the areas interpolated among them.

VR and AR may require fairly high data rates and strictly bounded latency conditions to satisfy the end-user quality of experience (QoE). As an example, CG may require 30 Mbps (for full high definition, FHD, resolution) to 45 Mbps (for 4K resolution) with latency bounds of 15 ms. AR and VR services may be more demanding with tighter latency bounds of 10 ms. The XR data may arrive as frame bursts with 60 frames per second (fps). However, it should be noted that other fps rates are also possible. An XR user may be satisfied if 95%-99% of the XR frames are correctly received within the latency bound. It should be noted that these are just examples, and other XR traffic models and QoE constraints may also exist.

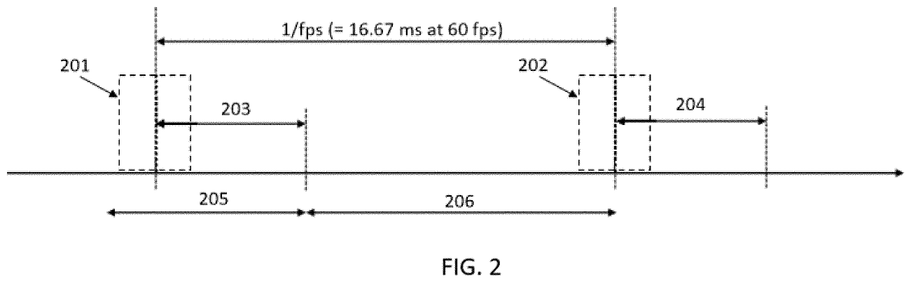

FIG. 2 illustrates an exemplary timing diagram for XR traffic, and desirable time windows for handovers (and beam changes). In other words, FIG. 2 shows an exemplary timing diagram that illustrates the XR frame bursts arrivals at the RAN. The XR frames arrive with an average rate of 60 fps in this example. The arrival of a given XR frame may be subject to a jitter window 201, 202. After the arrival of the XR frame during the jitter window, the gNB has a short latency window 203, 204, during which it should ensure that the XR frame is reliably (safely) transmitted to the UE (and correctly received by the UE). During a time window 205, which includes the jitter window and the latency window, the UE should be on for XR reception, and also potential uplink transmission.

Similarly, timely and reliable uplink XR service should be ensured as well. During the latency windows 203, 204, during which the gNB is transmitting XR frames, it may be undesirable to have RRC-based inter-cell handovers happening, as they may result in a temporary interruption in the data connection. Thus, there may be an ideal time window 206 outside of the latency windows 203, 204 that are used for XR transmissions. During this ideal time window 206, it may be desirable to start handover execution (and potentially also MAC-based beam changes).

Some exemplary embodiments may provide an enhanced CHO procedure, wherein the handover execution is controlled to start at specific times that do not collide with the transmission of XR frames.

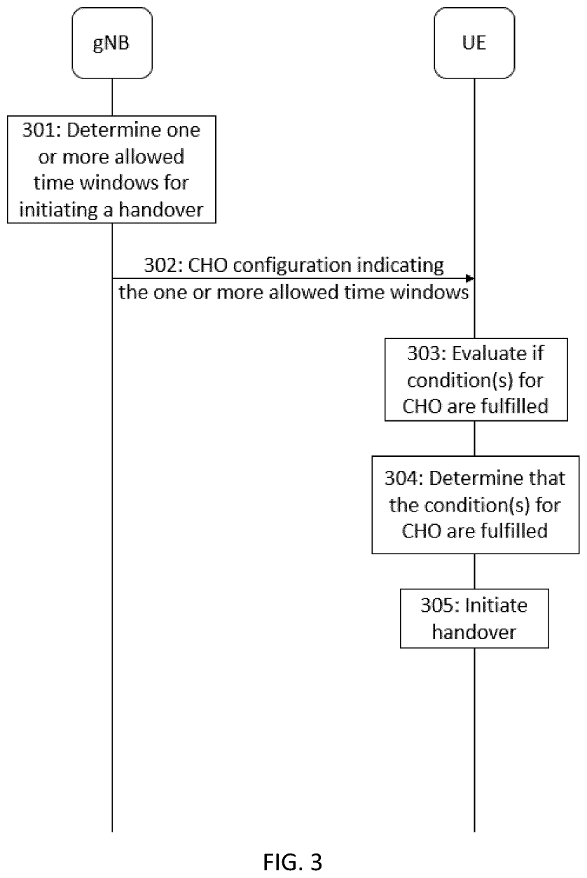

FIG. 3 illustrates a signalling diagram according to an exemplary embodiment. Referring to FIG. 3, a source gNB determines 301 one or more time windows, during which a UE is not expected to receive downlink data from the source gNB or transmit uplink data to the source gNB. The source gNB is the current serving cell of the UE. Herein the downlink data and the uplink data may refer to user plane packets associated with an XR service.

The source gNB transmits 302, to the UE, an RRC reconfiguration message for CHO, wherein the RRC reconfiguration message indicates that the UE is allowed to initiate a handover during the one or more time windows determined by the source gNB. It should be noted that the UE is not allowed to initiate a handover outside of the indicated one or more time windows. The one or more time windows may be indicated explicitly in the RRC reconfiguration message, for example in a conditionalReconfiguration information element or in a dedicated information element for that purpose. The RRC reconfiguration message further comprises a handover command with a CHO configuration of one or more candidate gNBs, wherein the CHO configuration comprises one or more conditions for executing the handover command. The source gNB may also prepare the one or more candidate gNBs for the handover.

The UE evaluates 303, or monitors, if the one or more conditions for the handover are fulfilled. After determining 304 that the one or more conditions are fulfilled within the one or more time windows indicated by the source gNB, the UE initiates 305 a handover (i.e. starts executing the handover command received from the source gNB) during one of the one or more time windows indicated by the source gNB. In other words, the UE changes from the source gNB to be served by a target gNB, which is one of the candidate gNBs (e.g. a neighbour gNB). The UE may transmit a CHO confirmation message to the target gNB to indicate successful completion of the handover, and the target gNB may then perform a path switch and UE context release in order to inform the source gNB of the completed handover, so that the source gNB can cancel the resources reserved by the remaining candidate gNBs.

If the one or more conditions for the handover are fulfilled outside of the one or more time windows indicated by the source gNB, the UE may delay the handover execution until the earliest time of the next allowed time window. The UE may also delay initiating the handover, if the one or more conditions are fulfilled while an uplink user plane data transmission is incomplete or a downlink user plane data reception is incomplete.

As a non-limiting example, the one or more conditions may be fulfilled, if a CHO event A3 or CHO event A5 is triggered, while the current time is within the one or more time windows. If the condition is triggered outside of the one or more time windows indicated by the source gNB, then the UE may delay the handover execution until the earliest time of the next allowed time window for handover execution. For example, the CHO event A3 may be triggered when the RSRP and/or RSRQ of a candidate gNB indicated in the CHO configuration exceeds the RSRP and/or RSRQ of the source gNB by an offset.

The functions and/or blocks described above by means of FIG. 3 are in no absolute chronological order, and some of them may be performed simultaneously or in an order differing from the described one. Other functions and/or blocks may also be executed between them or within them.

In some exemplary embodiments, the one or more time windows may be indicated with a periodicity, a phase offset, and a duration of a given time window.

The periodicity indicates the time between the time windows. The periodicity may be expressed as a time value, in units of subframes (e.g. 1 subframe=1 ms in NR), number of slots, or number of symbols. For cases where it is expressed in units of slots or symbols, the periodicity may be based on the subcarrier spacing of the UE's currently used active bandwidth part (BWP), as different BWPs may use different subcarrier spacings. As an alternative to explicitly expressing the time between the time windows, the periodicity may be indicated as a value of time windows per second (i.e. the frequency of such time windows). The periodicity may correspond with an fps value of an XR service, or some other communication service such as an industrial internet of things (IIoT) service or an ultra-reliable low latency communication (URLLC) service. As a non-limiting example, the periodicity may be indicated as a frequency of 60 time windows per second corresponding with an XR fps of 60.

The phase offset indicates the phase shift of the time window pattern. The phase offset may be expressed, for example, as a time offset relative to the frame boundary for a given system frame number (SFN).

The duration indicates the time duration of a given time window, during which the UE is allowed to initiate a handover. The duration may be expressed as a time value, in units of subframes (e.g. 1 subframe=1 ms in NR), number of slots, or number of symbols. It should be noted that the time duration of slots and symbols depends on the configured subcarrier spacing. For such cases, the duration may be based on the subcarrier spacing of the UE's currently used active BWP, as different BWPs may use different subcarrier spacings.

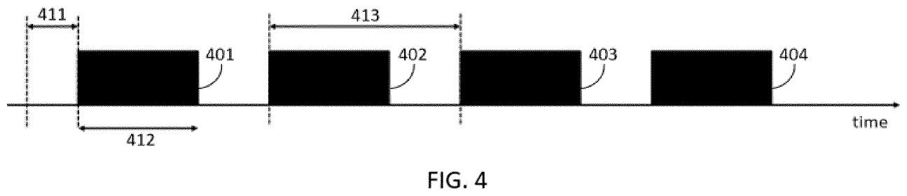

FIG. 4 illustrates an example of a time window pattern according to an exemplary embodiment. In this example, the UE is allowed to initiate a handover during the time windows 401, 402, 403, 404, and the time window pattern is a regular periodic pattern. For example, the source gNB may indicate the time windows 401, 402, 403, 404 to the UE with the phase offset 411 of the pattern, the duration 412 of a given time window, and the periodicity 413 at which the time windows are repeated.

In another exemplary embodiment, an irregular time window pattern may be used (e.g. the time interval between a first time window and a second time window may be different than the time interval between the second time window and a third time window), and the duration may vary among the time windows (e.g. a first time window may have a different duration than a second time window).

In another exemplary embodiment, the time window pattern, during which the UE is allowed to initiate a handover, may be even more flexibly expressed as a pattern that is repeated every N*10 ms radio frame(s), where N is an integer N∈[1,2,3, . . . ]. In other words, the time windows may be repeated every 10 ms (for N=1), or every 20 ms (for N=2), or every 30 ms (for N=3), and so forth. Within those N*10 ms radio frames, the time-domain time window(s) may be indicated with a vector of binary elements having a length (or size) of M, where M is equal to a number of slots within the N*10 ms radio frame(s). The length of the vector refers to the number of binary elements comprised in the vector. For example, for 15 kHz SCS, M=N*10. For 30 KHz SCS, M=N*10*2. For 60 KHz SCS, M=N*10*4, and so forth. For example, when a binary element in the vector is set to one, it means that the UE is allowed to initiate a handover at this particular point in time, while a zero means the UE is not allowed to initiate a handover at this particular point in time.

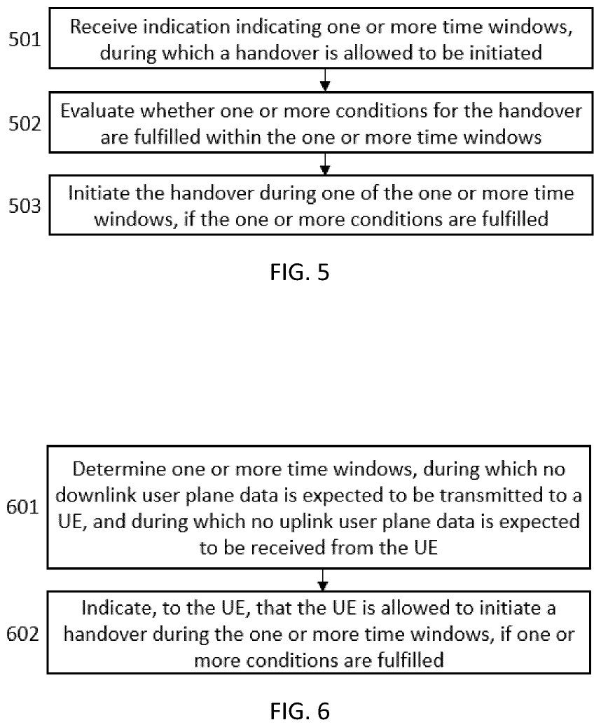

FIG. 5 illustrates a flow chart according to an exemplary embodiment. The functions illustrated in FIG. 5 may be performed by an apparatus such as, or comprised in, a UE. Referring to FIG. 5, an indication indicating one or more time windows, during which a handover is allowed to be initiated, is received 501 from a base station. It is evaluated 502 whether one or more conditions for the handover are fulfilled within the one or more time windows. The handover is initiated 503 during one of the one or more time windows, if the one or more conditions are fulfilled based on the evaluating. During the handover, the apparatus may be handed over from the base station to another base station.

FIG. 6 illustrates a flow chart according to an exemplary embodiment. The functions illustrated in FIG. 6 may be performed by an apparatus such as, or comprised in, a base station (for example a gNB). Referring to FIG. 6, one or more time windows, during which no downlink user plane data is expected to be transmitted to a UE, and during which no uplink user plane data is expected to be received from the UE, are determined 601. An indication (e.g. a configuration) is transmitted 602 to the UE, wherein the indication indicates that the UE is allowed to initiate a handover during the one or more time windows, if one or more conditions are fulfilled.

The functions and/or blocks described above by means of FIGS. 5-6 are in no absolute chronological order, and some of them may be performed simultaneously or in an order differing from the described one. Other functions and/or blocks may also be executed between them or within them.

A technical advantage provided by some exemplary embodiments is that they allow the network to control that the handover initiated by the UE occurs outside of the time periods, during which e.g. XR frames are being transmitted. This means that the number of XR frames that are affected by the handover may be reduced, and hence the probability for fulfilling the XR quality of service (Qos) requirements may be increased.

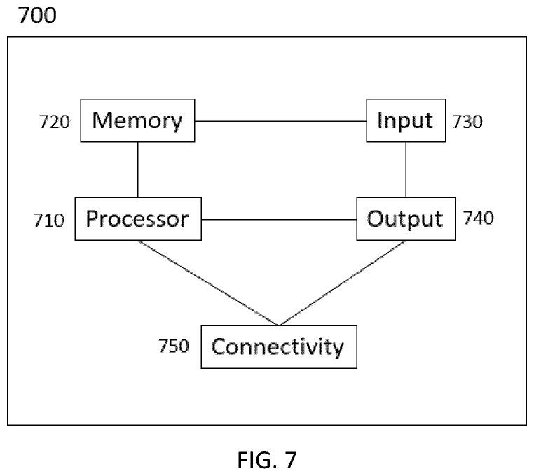

FIG. 7 illustrates an apparatus 700, which may be an apparatus such as, or comprised in, a terminal device, according to an exemplary embodiment. A terminal device may also be referred to as a UE or user equipment herein. The apparatus 700 comprises a processor 710. The processor 710 interprets computer program instructions and processes data. The processor 710 may comprise one or more programmable processors. The processor 710 may comprise programmable hardware with embedded firmware and may, alternatively or additionally, comprise one or more application-specific integrated circuits (ASICs).

The processor 710 is coupled to a memory 720. The processor is configured to read and write data to and from the memory 720. The memory 720 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 720 stores computer readable instructions that are executed by the processor 710. For example, non-volatile memory stores the computer readable instructions and the processor 710 executes the instructions using volatile memory for temporary storage of data and/or instructions.

The computer readable instructions may have been pre-stored to the memory 720 or, alternatively or additionally, they may be received, by the apparatus, via an electromagnetic carrier signal and/or may be copied from a physical entity such as a computer program product. Execution of the computer readable instructions causes the apparatus 700 to perform one or more of the functionalities described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer.

The apparatus 700 may further comprise, or be connected to, an input unit 730. The input unit 730 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 730 may comprise an interface to which external devices may connect to.

The apparatus 700 may also comprise an output unit 740. The output unit may comprise or be connected to one or more displays capable of rendering visual content, such as a light emitting diode (LED) display, a liquid crystal display (LCD) and/or a liquid crystal on silicon (LCoS) display. The output unit 740 may further comprise one or more audio outputs. The one or more audio outputs may be for example loudspeakers.

The apparatus 700 further comprises a connectivity unit 750. The connectivity unit 750 enables wireless connectivity to one or more external devices. The connectivity unit 750 comprises at least one transmitter and at least one receiver that may be integrated to the apparatus 700 or that the apparatus 700 may be connected to. The at least one transmitter comprises at least one transmission antenna, and the at least one receiver comprises at least one receiving antenna. The connectivity unit 750 may comprise an integrated circuit or a set of integrated circuits that provide the wireless communication capability for the apparatus 700. Alternatively, the wireless connectivity may be a hardwired application-specific integrated circuit (ASIC). The connectivity unit 750 may comprise one or more components such as a power amplifier, digital front end (DFE), analog-to-digital converter (ADC), digital-to-analog converter (DAC), frequency converter, (de)modulator, and/or encoder/decoder circuitries, controlled by the corresponding controlling units.

It is to be noted that the apparatus 700 may further comprise various components not illustrated in FIG. 7. The various components may be hardware components and/or software components.

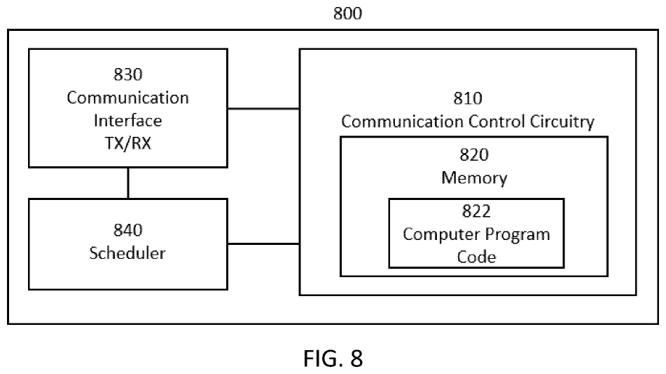

The apparatus 800 of FIG. 8 illustrates an exemplary embodiment of an apparatus such as, or comprised in, a base station such as a gNB. The apparatus may comprise, for example, a circuitry or a chipset applicable to a base station for realizing some of the described exemplary embodiments. The apparatus 800 may be an electronic device comprising one or more electronic circuitries. The apparatus 800 may comprise a communication control circuitry 810 such as at least one processor, and at least one memory 820 including a computer program code (software) 822 wherein the at least one memory and the computer program code (software) 822 are configured, with the at least one processor, to cause the apparatus 800 to carry out some of the exemplary embodiments described above.

The processor is coupled to the memory 820. The processor is configured to read and write data to and from the memory 820. The memory 820 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 820 stores computer readable instructions that are executed by the processor. For example, non-volatile memory stores the computer readable instructions and the processor executes the instructions using volatile memory for temporary storage of data and/or instructions.

The computer readable instructions may have been pre-stored to the memory 820 or, alternatively or additionally, they may be received, by the apparatus, via an electromagnetic carrier signal and/or may be copied from a physical entity such as a computer program product. Execution of the computer readable instructions causes the apparatus 800 to perform one or more of the functionalities described above.

The memory 820 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some exemplary embodiments, structures of the frames used in the detected neighbour cells.

The apparatus 800 may further comprise a communication interface 830 comprising hardware and/or software for realizing communication connectivity according to one or more communication protocols. The communication interface 830 comprises at least one transmitter (TX) and at least one receiver (RX) that may be integrated to the apparatus 800 or that the apparatus 800 may be connected to. The communication interface 830 provides the apparatus with radio communication capabilities to communicate in the cellular communication system. The communication interface may, for example, provide a radio interface to terminal devices. The apparatus 800 may further comprise another interface towards a core network such as the network coordinator apparatus and/or to the access nodes of the cellular communication system. The apparatus 800 may further comprise a scheduler 840 that is configured to allocate resources.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s)), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of exemplary embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the exemplary embodiments described above, but may vary within the scope of the claims. Therefore, all words and expressions should be interpreted broadly, and they are intended to illustrate, not to restrict, the exemplary embodiments.

### LIST OF ABBREVIATIONS

4G: fourth generation
5G: fifth generation
ADC: analog-to-digital converter
AR: augmented reality
ASIC: application-specific integrated circuit
BBU: baseband unit
BWP: bandwidth part
CG: cloud gaming
CHO: conditional handover
CN: core network
CPS: cyber-physical system
CSSP: customer-specific standard product
CU: central unit
CU-CP: central unit control plane
CU-UP: central unit user plane
DAC: digital-to-analog converter
DAPS: dual active protocol stack
DFE: digital front end
DRAM: dynamic random-access memory
DSP: digital signal processor
DSPD: digital signal processing device
DU: distributed unit
EEPROM: electronically erasable programmable read-only memory
FHD: full high definition
FPGA: field programmable gate array
fps: frames per second
GEO: geostationary earth orbit
gNB: next generation nodeB/5G base station
GPU: graphics processing unit
HNB-GW: home node B gateway
IMS: internet protocol multimedia subsystem
IIoT: industrial internet of things
IoT: internet of things
L1: Layer 1
L2: Layer 2
L3: Layer 3
LCD: liquid crystal display
LCOS: liquid crystal on silicon
LED: light emitting diode
LEO: low earth orbit
LTE: long term evolution
LTE-A: long term evolution advanced
M2M: machine-to-machine
MAC: medium access control
MANET: mobile ad-hod network
MEC: multi-access edge computing
MIMO: multiple input and multiple output
MME: mobility management entity
mMTC: massive machine-type communications
MR: mixed reality
ms: millisecond
MT: mobile termination
NFV: network function virtualization
NGC: next generation core
NR: new radio
PCell: primary cell
PCS: personal communications services
PDA: personal digital assistant
PDCP: packet data convergence protocol
P-GW: packet data network gateway
PHY: physical
PLD: programmable logic device
PROM: programmable read-only memory
PSCell: primary secondary cell
QoE: quality of experience
QoS: quality of service
RAM: random-access memory
RAN: radio access network
RAP: radio access point
RAT: radio access technology
RI: radio interface
RLC: radio link control
ROM: read-only memory
RRC: radio resource control
RSRP: reference signal received power
RSRQ: reference signal received quality
RU: radio unit
RX: receiver
SDAP: service data adaptation protocol
SDN: software defined networking
SDRAM: synchronous dynamic random-access memory
SFN: system frame number
S-GW: serving gateway
SIM: subscriber identification module
SINR: signal-to-interference-plus-noise ratio
SN: secondary node
SoC: system-on-a-chip
SpCell: special cell
TRX: transceiver
TTT: time-to-trigger
TX: transmitter
UE: user equipment/terminal device
UMTS: universal mobile telecommunications system
URLLC: ultra-reliable low latency communication
UTRAN: UMTS radio access network
UWB: ultra-wideband
vCU: virtualized central unit
vDU: virtualized distributed unit
VR: virtual reality
WCDMA: wideband code division multiple access
WiMAX: worldwide interoperability for microwave access
XR: extended reality

1. An apparatus comprising at least one processor, and at least one memory including computer program code, wherein the at least one memory and the computer program code are configured, with the at least one processor, to cause the apparatus to:
receive an indication indicating one or more time windows, during which a handover is allowed to be initiated;
evaluate whether one or more conditions for the handover are fulfilled within the one or more time windows; and
initiate the handover during one of the one or more time windows, if the one or more conditions are fulfilled.

2. The apparatus according to claim 1, wherein the handover is delayed to be initiated during the one of the one or more time windows, if the one or more conditions are fulfilled outside of the one or more time windows.

3. The apparatus according to claim 1, wherein the initiating of the handover is delayed, if the one or more conditions are fulfilled while an uplink user plane data transmission is incomplete or a downlink user plane data reception is incomplete.

4. The apparatus according to claim 1, wherein the one or more time windows are indicated with a periodicity, a phase offset, and a duration of the one or more time windows.

5. The apparatus according to claim 4, wherein the periodicity is indicated as a number of time windows per second.

6. The apparatus according to claim 5, wherein the number of time windows per second corresponds with a frames-per-second value associated with a service.

7. The apparatus according to claim 4, wherein the periodicity and/or the duration is based on a subcarrier spacing of an active bandwidth part used by the apparatus.

8. The apparatus according to claim 1, wherein the one or more time windows are indicated with a vector of binary elements, wherein the binary elements indicate whether or not the handover is allowed to be initiated at a given point in time.

9. The apparatus according to claim 8, wherein a length of the vector is equal to a number of slots within one or more radio frames, and wherein the one or more time windows are repeated according to the one or more radio frames.

10. The apparatus according to claim 1, wherein the indication indicating the one or more time windows is received in a radio resource control reconfiguration message, wherein the radio resource control reconfiguration message further indicates the one or more conditions for the handover.

11. The apparatus according to claim 1, wherein the one or more time windows comprise at least a first time window, a second time window and a third time window;
wherein a first duration of the first time window is different than a second duration of the second time window, and/or wherein a first time interval between the first time window and the second time window is different than a second time interval between the second time window and the third time window.

12. (canceled)

13. An apparatus comprising at least one processor, and at least one memory including computer program code, wherein the at least one memory and the computer program code are configured, with the at least one processor, to cause the apparatus to:
determine one or more time windows, during which no downlink user plane data is expected to be transmitted to a terminal device, and during which no uplink user plane data is expected to be received from the terminal device; and
indicate, to the terminal device, that the terminal device is allowed to initiate a handover during the one or more time windows, if one or more conditions are fulfilled.

14. The apparatus according to claim 13, wherein the indicating causes the terminal device to initiate the handover during one of the one or more time windows.

15. The apparatus according to claim 13, wherein the one or more time windows are indicated with a periodicity, a phase offset, and a duration of the one or more time windows.

16. The apparatus according to claim 15, wherein the periodicity is indicated as a number of time windows per second.

17. The apparatus according to claim 16, wherein the number of time windows per second corresponds with a frames-per-second value associated with a service.

18. The apparatus according to claim 17, wherein the downlink user plane data and the uplink user plane data are associated with the service.

19. The apparatus according to claim 15, wherein the periodicity and/or the duration is based on a subcarrier spacing of an active bandwidth part used by the apparatus.

20. The apparatus according to claim 13, wherein the one or more time windows are indicated with a vector of binary elements, wherein the binary elements indicate whether or not the handover is allowed to be initiated at a given point in time.

21. The apparatus according to claim 20, wherein a length of the vector is equal to a number of slots within one or more radio frames, and wherein the one or more time windows are repeated according to the one or more radio frames.

22.-31. (canceled)
